(19) United States
(12) Patent Application Publication
(10) Pub. No.: US 2005/0187963 A1
(43) Pub. Date: Aug. 25, 2005

(54) Security and compliance testing system and method for computer systems

(76) Inventor: Steven Markin, Armonk, NY (US)

Correspondence Address: Stephen E. Feldman, P.C., 12 East 41st Street, New York, NY, 10017, US

(21) Appl. No.: 10/783,814

(22) Filed: Feb. 20, 2004

(51) Int. Cl. G06F 17/00

(52) U.S. Cl. 707/102

(57) ABSTRACT

A security and compliance testing system comprises a vulnerabilities, regulations, priority, and results database. A relational database maps the contents of the vulnerabilities and regulations databases to each other. A target is tested and discovered vulnerabilities are mapped to violated regulations with the relational database. The violations are then prioritized according to the priority database and a report generated and stored on the results database.

### FIELD OF THE INVENTION

The present invention deals with security testing to ensure compliance of information systems with certain regulations.

### BACKGROUND OF THE INVENTION

In information technology (IT), a network is a series of computers, also known as points or nodes, interconnected by communication paths. Networks can interconnect with other networks, making them vulnerable to unauthorized access (hacking).

In general, a server is a computer program that provides services to other computer programs. The computer running a server program is also frequently referred to as a server, even though it may contain a number of server and client programs. In the client/server programming model, a server is a program that fulfills requests from client programs, which may reside on the same computer, or on other computers communicating via a network.

Specific to the Web, a Web server is the computer program that handles requests for data in the form of pages or files. A Web client is the requesting program associated with the user. The Web browser is a program on the Web client that issues the requests.

A database is a collection of data organized easy access, management, and updating. Databases contain aggregations of data records or files, such as sales transactions, product catalogs, inventories, and customer profiles. They provide the foundation for the technology that collects, stores, and manages information. Typically, a database manager provides users the capabilities of controlling read/write access, specifying report generation, and analyzing usage. No matter the location, a database is usually connected to a network, opening the door to possible hacking.

In business, a security policy is a document that states how a company plans to protect its physical (paper documents) and IT assets (computer networks and the information residing therein). A security policy is often considered to be a “living document”, meaning that the document is never finished, but is continuously updated as technology and employee requirements change. A company's security policy may include an acceptable use policy, a description of how the company plans to educate its employees about protecting the company's assets, an explanation of how security measurements will be carried out and enforced, and a procedure for evaluating the effectiveness of the security policy to ensure that necessary corrections will be made.

IT assets may reside on servers, databases, or some combination of both to enable sharing and easy access to data within an organization, limited to authorized personnel for security concerns. It is possible, however, that hackers may be able to access a network and retrieve proprietary information or manipulate data in some way. Industries dealing with confidential information, such as the banking industry or health care industry, are regulated by formal state and federal legislation to maintain data in a specific manner to ensure secure data storage, handling and access.

The Health Insurance Portability and Accountability Act (HIPAA) of 1996 is one example. The law mandates significant changes in the legal and regulatory environments governing the provision of health benefits, the delivery and payment of healthcare services, and the security and confidentiality of individually identifiable, protected health information.

To reduce the cost of health insurance, HIPAA also includes an administrative simplification section to encourage electronic transactions. Because of the electronic transactions, HIPAA includes a host of new regulations to assure the security and privacy of electronically stored medical data. The regulations set standards for electronic transactions, the privacy of all medical records and all identifiable health information and the security of electronically stored information.

To be HIPPA compliant, a healthcare practice must implement specific procedures to provide patients access to their medical information, including providing copies at their request, the ability to amend records, and accounting any and all disclosures of medical information for any use other than treatment, payment, and firm operations. Fines, penalties and possible jail time can be imposed for non-compliance.

Another example of IT regulation is the Graham Leach Bailey Act (GLBA) which regulates data security in the financial services industry. The Federal Financial Institutions Examination Council (FFIEC) recently issued guidance that expands the GLBA requiring financial institutions to protect all information assets, not just customer information.

It is important, therefore, to periodically ensure the integrity of network security. To do so, network scanning tools were developed. A security scanner is a software tool that audits a given network to determine its level of security. An example can be found in U.S. Pat. No. 6,584,569 to Reshef et al. which purports to disclose a scanner for automatically detecting potential application level vulnerabilities or security flaws in a web application. The system is supposed to check the security of a Web application, to ensure hackers cannot send malicious or forged data to the server. Scanning for security vulnerabilities alone, however only eliminates the most obvious security threats. In addition, Reshef does not consider compliance. Applications are tested for security weaknesses only.

With network security coming under scrutiny by the law, the need has arisen to ensure network security compliance. U.S. Patent Application 2003/0004754 to Krutz purports to disclose a Compatability Maturity Model (CMM) assessment method for evaluating compliance with HIPPA using a pre-existing CMM framework originally developed for measuring the quality and maturity level of an organization's software development process, but is extended to Systems Engineering and Systems Security Engineering. Krutz is limited to HIPPA and the pre-existing CMM framework, which it merely applies to a system with HIPPA regulations.

None of these disclosures sufficiently address the need to directly associate particular regulations with the particular security vulnerability errors, their severity, or means of remediation.

### SUMMARY OF THE INVENTION

In accordance with an embodiment of the present invention, an adaptable and universal security and compliance testing system and method are provided that can accommodate government regulations or private corporate security policies on disparate computing platforms, network architectures, operating systems, and applications by using centralized and universal vulnerability definitions mapped to a set of regulations. The mapping is applied to security screening results to determine what vulnerabilities, if any, exist with their corresponding regulations that are being violated. The violations may then be prioritized.

A method for checking security and compliance of a network comprises providing a database of vulnerabilities and a database of regulations. The vulnerabilities data is taken from some centralized, universal vulnerabilities list that acts as a dictionary for terms with the same definition across multiple technologies. Regulations data is taken from a specific set of regulations in a law or corporate policy. Particular areas of security concerns are identified by keywords. Using each keyword, the vulnerabilities and regulations databases are searched for matches. Each match is grouped with its corresponding keyword and this data is preferably entered into a relational database to provide a mapping between vulnerabilities and regulations.

A target system configuration is determined and a customized security scanning configured for that specific target. The scanning is executed and the resulting vulnerabilities found on the target are cross-referenced with the mapping to determine what regulations are being violated. The violations can then be prioritized using a priority database.

### BRIEF DESCRIPTION OF THE DRAWINGS

FIG. 1 is a diagram of a system according to an embodiment of the present invention connected to the Internet.

FIG. 2 is a flowchart for an exemplary method according to an embodiment of the present invention.

### DETAILED DESCRIPTION

The present invention provides a system and a method for effectively and efficiently identifying violations of privacy and security regulations and guidelines in information systems, such as computer networks, of regulated entities while documenting and accommodating the live (always changing) process of compliance and security testing. Part of which includes prioritizing security issues to identify which issues need to be remedied, and in what order to satisfy a particular compliance security policy. Regulated entities are defined by the applicable set of regulations, e.g., HIPPA regulates, among others, health care providers while GLBA regulates financial institutions.

Private entities may also be regulated as they are subject to self-policing and have an interest in protecting their IT assets by enforcing their own security policy. A security policy is a set of regulations just the same as government regulations imposed by law. The present invention, therefore, is not limited to testing systems for compliance with government regulations, but with any regulations concerning information system security. For example, a law firm that maintains confidential attorney-client subject matter in digital format has a duty to protect that information. At present, there is so formal legislation to govern how such data should be managed, however, it would be foolish not to devise and strictly enforce a security policy. The present invention may be adapted to test compliance of an information system with such a security policy.

Most information security testing systems include a database of security vulnerabilities and exposures (publicly known facts about computer systems that could potentially create a security problem). There is, however, significant variation between testing systems and no easy way to determine when different databases refer to the same problem, creating potential gaps in security coverage and no effective interoperability among disparate databases and tools. Compounding the problem, security testers typically use different metrics to state the number of vulnerabilities or exposures they detect, creating a lack of a standardized basis for tool evaluation.

The present invention, therefore, uses a vulnerabilities dictionary with universal definitions applicable to different platforms, programming languages, hardware, software, etc. The dictionary should provide:
One name for one vulnerability or exposure.
A dictionary with one standardized description for each vulnerability or exposure, as opposed to a database good for only one tool.
A way for disparate databases and tools to communicate in a universal language.
A basis for evaluation among tools and databases to determine what each tool covers and its effectiveness.
Easy updates.

Common Vulnerabilities and Exposures (CVE®) is a list of standardized names for vulnerabilities and other information security exposures, providing standard nomenclature for all publicly known vulnerabilities and security exposures, thus making it easier to share data across separate vulnerability databases and security tools. CVE is particularly well-suited to provide a sufficient vulnerabilities and exposures dictionary.

The content of CVE is a result of a collaborative effort of the CVE Editorial Board. The Editorial Board includes representatives from numerous security-related organizations such as security tool vendors, academic institutions, and government as well as other prominent security experts. The MITRE Corporation maintains CVE and moderates Editorial Board discussions. Through open and collaborative discussions, the Board identifies which vulnerabilities or exposures are included in CVE, then determine the common name and description for each entry.

Candidates for CVE (CAN) are submitted to the Board from the IT security industry and community. The Board reviews the CANs and selects those that pose a serious and common enough threat to be assigned a name and included in an official CVE version.

According to an embodiment of the present invention, a processor, such as a computer, is connected to a number of databases, each with a specific type of information. Alternatively, all the information can be stored in one database, server, or servers, but for ease of illustration, this example will assume distinct databases.

A Regulations Database stores a set of regulations with associated, identifying information. For example, a regulation may have a number, title, and description. All would be maintained, together, in the Regulations Database. The regulations may come from a private corporate security policy or government regulation as mandated by law, e.g., HIPAA. Regulation data, regulation names, descriptions, etc., are entered into the database. If the regulations are coming from public law, the information is taken directly from the statute. With regard to HIPAA, or GLBA, for each regulation in the respective statute, its title, description, and rule are entered into the database. This is only a simplified example, more, or less, information may be entered in as much detail as desired.

If the regulations are coming from a private, corporate entity, they should be organized similar to statutes, by section and subsections grouped by common threads. Better organization of the security policy eases the data entry process into the Regulations Database.

Password vulnerabilities provide a good basis for an example because of its common use and understanding. Access to information systems usually requires a password, tied to a specific user ID. So, the correct ID and password, together, are required for access. It is good security practice to periodically change a password. In addition, it is generally agreed that passwords should not be easily ascertainable, like using a person's last name, initials, or combination of an initial and a name. Default passwords are supplied with security software that should be changed immediately upon installation. Oftentimes, however, they are not. These generally accepted practices are simple examples of vulnerabilities, unchanged passwords, easily ascertainable passwords, and using default passwords.

Table 1 shows an exemplary entry into the Regulations Database. The regulations number is stored with a description, short description, and the regulation rule itself, grouped by a corresponding keyword, in this case, “password.” It should be noted that arbitrary HIPAA regulation numbers and rules have been created for the table. Because the regulations of HIPAA are publicly accessible, and available to all, it will be used as the framework for illustration and examples in this disclosure. The steps and principals set out herein may apply to any set of regulations, public or private.

TABLE 1
Exemplary Regulations Database Entry.

| | | | Regulation | |
|---|---|---|---|---|
| Keyword | Short Description | Description | No. | Rule |
| Password | Default password | A default | 1.1 | All default passwords |
| | | password has | | will be changed |
| | | not been | | immediately upon |
| | | changed from | | installation of any and |
| | | original | | all software, hardware |
| | | installation. | | and firmware. |
| Password | Stale password | A password | 1.2 | Password must be |
| | | hasn't been | | changed periodically, at |
| | | changed in over | | most every 6 months. |
| | | 6 months. | | |
| Password | Easily | A password | 1.3 | Passwords must not |
| | ascertainable | matches a user | | match their |
| | password | ID or some other | | corresponding ID, or |
| | | public fact about | | user name. |
| | | the user. | | |

A Vulnerabilies Database houses a list of security vulnerabilities, preferably with universal definitions applicable to different operating systems, like Windows and Linux, different platforms, such as PC and Mac, and different network architectures, among others. This example assumes the CVE is used. A universally accepted and standardized vulnerability definition is preferable because it provides a common language understood across different technologies, ensuring compatibility of the present invention with virtually any network. At the time of this writing, the CVE is the dominant vulnerability dictionary and provides the best fit. Again, it should be noted that another universal vulnerability listing may be used and the inclusion of the CVE is only used for providing an example. The Vulnerabilities Database, therefore, maintains the most current CVE version available, which in turn maintains the most current vulnerability listing and definitions available as the CVE is constantly updated and revised to reflect changes in information systems security.

Table 2 is an example of an entry in the Vulnerabilities Database using the previous password regulations with arbitrary CVE numbers and descriptions. For the sake of simplicity and ease of illustration, the descriptions are the same to make the relation between vulnerability and regulation clear.

TABLE 2
Exemplary Vulnerabilities Entry.

| Keyword | Short Description | Description | CVE No. | Vulnerability |
|---|---|---|---|---|
| Password | Default password | A default | 2004-1.1 | Default passwords |
| | | password has | | expose systems to |
| | | not been | | added liability. |
| | | changed from | | |
| | | original | | |
| | | installation. | | |
| Password | Stale password | A password | 2004-1.2 | Using the same |
| | | hasn't been | | password too long |
| | | changed in over | | makes the system |
| | | 6 months. | | easier to hack. |
| Password | Easily | A password | 2004-1.3 | Passwords matching |
| | ascertainable | matches a user | | their corresponding ID, |
| | password | ID or some other | | or the last or first name |
| | | public fact about | | of the user are too easy |
| | | the user. | | to guess. |

A Priority Database contains a list of vulnerabilities prioritized in a specific order. The priority ordering may be defined by occurrence, with the most common vulnerability having the highest priority, or by most critical where the most dangerous vulnerability has the highest priority. Alternatively, the priority may be predetermined by the regulations in the Regulations Database. For a simple example, there may be a regulation that states any vulnerability dealing with passwords should get highest priority. Here, again, the inventive system allows for adaptability and customization to accommodate different priority ranking schemes. Regardless of the scheme chosen, it is entered into the Priority Database.

The FBI/SANS database is an example of a priority scheme that can be stored on the Priority Database. The SANS Institute and the National Infrastructure Protection Center (NIPC) at the FBI maintain a Top Twenty that is actually two Top Ten lists: the ten most commonly exploited vulnerable services in Windows and the ten most commonly exploited vulnerable services in UNIX and Linux. Although there are thousands of security incidents each year affecting these operating systems, the overwhelming majority of successful attacks target one or more of these twenty vulnerable services.

The Top Twenty is a consensus list of vulnerabilities that require immediate remediation. It is the result of a process that brought together dozens of leading security experts from the most security-conscious federal agencies in the US, UK and Singapore; the leading security software vendors and consulting firms; the top university-based security programs; many other user organizations; and the SANS Institute.

The SANS Top Twenty is a living document. It includes step-by-step instructions and pointers to additional information useful for correcting the security flaws. The list, and it's instructions, are constantly updated as more critical threats and more current or convenient methods are identified.

A Relational Database is created from the Regulations, Vulnerabilities and Priority Databases. A relational database is a collection of data items organized as a set of formally-described tables from which data can be accessed or reassembled without having to reorganize the database tables.

To create the Relational Database, a relation, or common thread, is identified between vulnerabilities and regulations. The common thread, in this example, is a keyword established from the most significant security concerns. For example, if “password” is a keyword, all vulnerabilities in the Vulnerability Database that deal with passwords are grouped together. All regulations in the Regulations Database that deal with passwords are also grouped together, establishing which regulations have a corresponding vulnerability and vice-versa to establish a specific relationship between each regulation and vulnerability in the databases, known as mapping. Table 3 shows an exemplary relational database entry and mapping relationship using the previous password vulnerabilities example from Tables 1 and 2. The Priority Database is accessed to rank the entries in order, with their priority ranking included.

TABLE 3
Exemplary Relational Database and Mapping Relationship.

| Regulation | Reg | | Vulnerability | Vulnerability | | |
|---|---|---|---|---|---|---|
| Keyword | No. | Mapping | Identifier | Keyword | Description | Priority |
| password | 1.1 | [symbol] | 2004-1.1 | Password | Default pw | 1 |
| password | 1.2 | [symbol] | 2004-1.2 | Password | Stale pw | 2 |
| password | 1.3 | [symbol] | 2004-1.3 | Password | Ascertainable pw | 3 |

The Regulations Database is searched, using the keyword “password,” so that all the regulations with “password” are found and extracted. These regulations are “keyed” (related in the context of the relational database) to “password”. Again, for the sake of simplicity, only three simple password vulnerabilities are used. The same is done for the Vulnerabilities Database. It should be noted at this time that the order of searching is reversible, either regulations or vulnerabilities may be done first.

The password regulations and vulnerabilities found were matched (mapped to each other) by their description. In this example, an arbitrary naming convention is used. The nomenclature is irrelevant as long as each database has the pertinent information for each regulation and vulnerability organized together.

Referring to Table 3, it is easily ascertainable that Regulation 1.1 and Vulnerability 2004-1.1 both relate to the use of default passwords, as evident by their description, establishing a two-way mapping relationship, meaning that both relate to the other. Put another way, wherever Regulation 1.1 is violated, Vulnerability 2003-1.1 is present, and vice versa. The other mapping relationships for the other password vulnerabilities are evident from Table 3.

A Results Database stores the results of tests run on a specific system for generating reports including the vulnerabilities found, their IP addresses, regulation violations (compliance risks), a prioritization of remediation, and recommended remediation of the threat.

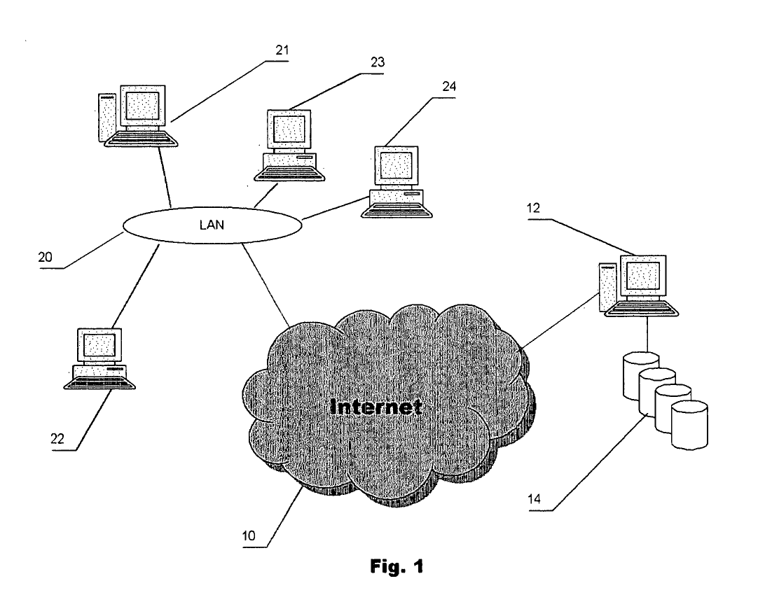

FIG. 1 shows an exemplary connection for the compliance testing system 12 and 14 to test a remote network 20 via the Internet 10. The system, in this case, comprises a computer 12 and the databases 14. The databases include the Regulations, Vulnerability, Priority, and Results Databases in addition to the relational database. The figure shows the databases 14 separate from the computer 12 for ease of illustration only. The databases 14 may physically reside on the computer 12, on a server (not shown), or on separate data storage hardware, as depicted.

A remote LAN 20 (local area network) is connected to the Internet 10 and includes a server 21 and a number of computers 22, 23 and 24. The LAN 20, together with the server 21 and computers 22, 23 and 24 is an example of an information system. Usually, the server 21 stores and manages access to protected data. The client computers 22, 23 and 24 request access, which is granted if the requests meet certain security requirements, like a proper ID and password combination. This is one example of a number of possible connection scenarios and architectures. All the host (testing system 12, 14) needs is a communicable connection with the target (LAN 20). The connection may be an Internet connection, LAN connection, telephone line, wireless link, etc. In addition, the target can be a single machine, as with one computer, or even a single application which may be one of several applications on one computer.

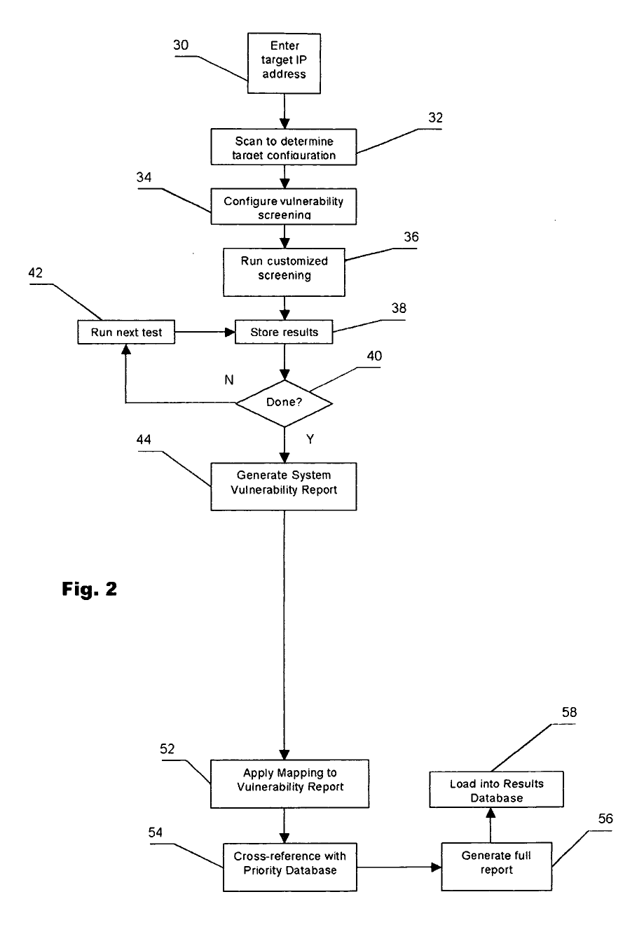

FIG. 2 depicts a flowchart for an exemplary compliance testing method according to an embodiment of the present invention. The system accepts, as input, an IP (Internet Protocol) address for the target to be tested (step 30). Every device connected to the Internet has an address, like a house, to corresponding to its location. To test a specific device, its IP address is input. For a network, the range of IP addresses for all the devices connected to the network are input. So in the case of the exemplary connection outlined above (see FIG. 1), the IP address range for the server 21 and all the devices 22, 23 and 24 connected to the LAN 20 are entered (step 30). For the sake of simplicity, assume the IP address for each computer is the same as its reference numeral. So, the server 21 has an IP address 22, the IP address of client computer 23 is 23, and so on.

Upon accepting the target IP address (step 30), the target is scanned to determine its configuration (step 32) and customize the vulnerability screening process (step 34). The scan determines the hardware, software and firmware on the target, in this case, the network 20, all connected devices 21, 22, 23, 24 and all the software running on those devices. For instance, applications, firewalls, servers, databases, peripherals (printers, scanners, fax machines, etc.), and operating systems, among others, can all be ascertained from the scan (step 30), which is a well-known process.

Using the scanning results, a custom security screening is configured including a number of tools specifically designed to test the devices and elements detected on the target. The testing tools used may be well-known, publicly available tools, proprietary tools, or any combination of both.

Customizing the screening process provides added efficiency and intelligent testing. For example, if, after scanning, it is determined that a target is running Windows, only security tests pertinent to Windows will be used. If, on the other hand, the target is running Linux, Linux tests are used instead of those designed for Windows. This customization is available at every level of a target, for hardware, operating system, peripherals, software applications, databases, servers, etc.

Once configured, the first test of the customized screening set is run (step 36) and its results stored in a screening results file (step 38), after which the system checks whether there are more tests in the custom screening to be run (step 40). If so, the next test level is run (step 42), and the results added to the screening results file (step 38). It should be noted that the decision to run another test (step 40) may include running the same test where there may be a number of scenarios to run with different parameters. For example, a password screening tool will run a number of times, each time using a different password. On the first pass, the tool may try the well-known default password for the particular application being tested (determined by the screening in step 32), on the next, several consecutive passes, try matching user IDs and passwords.

The testing loop (steps 38, 40 and 42) continues until all the tests in the customized set are completed (step 40), at which point all the results in the results file are merged to generate a Systems Vulnerability Report (step 44). Discovered system vulnerabilities are preferably grouped by IP address so the location of each vulnerability is known. So, for instance, the Report may state that IP address 23 (client computer 23 in FIG. 1) has a password related vulnerability, identifying the type and location of each vulnerability.

For a simple example, assume the Vulnerability Report (step 44) shows a default password at IP address 21, a stale password at IP address 23 that has not changed in over six months, and a password that matches its corresponding user name at IP address 24, making it easily ascertainable. No vulnerabilities were found at IP address 22. The report may be organized like Table 4.

TABLE 4
System Vulnerability Report.

| IP Address | Vulnerability |
|---|---|
| 21 | Default Password |
| 22 | No Vulnerability |
| 23 | Stale Password |
| 24 | Easily Ascertainable Password |

The mapping of Table 3 is applied to the Vulnerability Report (step 52) to determine which regulation each vulnerability violates. Referring to Tables 3 and 4, it is readily apparent which IP address has which vulnerability and the regulation it is violating, giving a clear picture of whether the network is in compliance with the regulations, which it clearly is not, and what to do to bring the network into compliance. In this case, passwords have to be changed at IP addresses 21, 23 and 24. With regard to the stale password vulnerability, a mandatory, periodic change of passwords should be implemented.

TABLE 5
Cross-reference of Vulnerability Report and Mapping.

| IP Address | Vulnerability | Reg. No. | Vulnerability ID |
|---|---|---|---|
| 21 | Default Password | 1.1 | 2004-1.1 |
| 22 | No Vulnerability | n/a | n/a |
| 23 | Stale Password | 1.2 | 2004-1.2 |
| 24 | Easily Ascertainable | 1.3 | 2004-1.3 |
| | Password | | |

The discovered regulation violations and vulnerabilities are cross-referenced with the Priority Database (step 54) to arrange Table 3 in a prioritized order. Alternatively, the priority ranking may be taken directly from the relational database (Table 3). Obviously, IP address 22 with no vulnerability should be the lowest priority. Using the ranking from Table 3, where Default Passwords rank the highest, the problem at IP address 21 has the highest priority and should be addressed first. The next highest priority addressed next, and so on.

Rather than rank specific vulnerabilities, the priority scheme may organize vulnerabilities into classes, and assign each class a danger level, from critical to low.

Critical vulnerabilities would be those that typically affect default installations of very widely deployed software, result in root compromise of servers or infrastructure devices, and the information required for exploitation (such as example exploit code) is widely available to attackers. Further, exploitation may be straightforward, in the sense that the attacker does not need any special authentication credentials, knowledge about individual victims, and does not need to social engineer a target user into performing any special functions.

High vulnerabilities would be those with the potential to become critical, but has a mitigating factor or factors that make exploitation less attractive to attackers. For example, vulnerabilities that have many critical characteristics but are difficult to exploit, do not result in elevated privileges, or have a minimally sized victim pool may usually be rated high. Note that high vulnerabilities where the mitigating factor arises from a lack of technical exploit details will become critical if these details are later made available. Thus, it may be advantageous to treat such high vulnerabilities as critical, and assume that attackers always possess the necessary exploit information.

Moderate vulnerabilities may be classified as those where the scales are slightly tipped in favor of the potential victim. Denial of service vulnerabilities are an example of a moderate vulnerability, since they do not compromise a target. Exploits that require an attacker to reside on the same local network as a victim, only affect nonstandard configurations or obscure applications, require the attacker to social engineer individual victims, or where exploitation only provides very limited access may be considered moderate.

Low vulnerabilities by themselves would typically have very little impact on an organization's infrastructure. These vulnerabilities would usually require local or physical system access, or may result in client side privacy or denial of service issues and information leakage of organizational structure, system configuration and versions, or network topology. Alternatively, a low ranking may be applied when there is not enough information to fully assess the implications of a specific vulnerability.

By default, a full report is generated (step 56) that includes the vulnerabilities for each IP address, violated regulations, and priority ranking. The results of the entire process are loaded into the Results Database (step 58) for future reference and to generate custom reports. A delta report may be generated as well, showing changes in the network between two or more scans, using past results in the Results Database, crucial for compliance where a regulation requires documentation of ongoing vulnerability assessment and reasonable efforts to remedy known problems. Where the FBI/SANS is used in the Priority Database, the instructions maintained there for addressing security concerns can be included in the report as recommendations for remediation.

The entire process is repeated recursively and periodically, usually according to the regulations or security policy being enforced.

A more complex and fairly accurate example of an entry into the relational database is shown in Table 6 using actual CVE and HIPPA descriptions and numbers.

TABLE 6
Relational Database Example.

| Keyword | Gain Root | Execute Code | Buffer Overflow | Modify |
|---|---|---|---|---|
| Reg. No. | 164.312(a)(1) | 164.312(a)(1) | 164.308(5)(b) | 164.312(c)(1) |
| Violation | Additional, | Unauthorized | System, susceptible to | Unauthorized |
| | unauthorized access | code execution | buffer overflow | user may modify |
| | may be granted | | | data |
| Reg. Des. | Access must be | Access must be | Guard against malicious | Protect |
| | properly secured | properly secured | software | information from |
| | | | | alteration or |
| | | | | destruction |
| SANS/FBI | W1 | W3 | U1 | W8 |
| CVE | CVE-2001-0241 | CVE-2002-1123 | CVE-1999-0977 | CVE-2001-0727 |
| CVE Des. | Buffer Overflow in | Buffer overflow | Buffer overflow in Solaris | Internet Explorer |
| | Internet Printing | in the | sadmind allows remote | 6.0 allows remote |
| | ISAPI in Windows | authentication | attackers to gain root | attackers to |
| | 2000 allows remote | function for | privileges using | execute arbitrary |
| | attackers to gain | Microsoft SQL | NETMGT_PROC_WERVI | code by modifying |
| | root privileges via a | Server 2000 and | CE request. | the Content- |
| | long print request | Microsoft | | Disposition and |
| | passed through IIS | Desktop Engine | | Content-Type |
| | 5.0. | (MSDE) 2000 | | header fields in a |
| | | allows remote | | way that causes |
| | | attackers to | | Internet Explorer |
| | | execute arbitrary | | to believe that the |
| | | code via a long | | file is safe to open |
| | | request to TCP | | without prompting |
| | | port 1433, aka | | the user. |
| | | the “Hello” | | |
| | | overflow. | | |

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

1. A method for testing compliance of a target comprising the steps of:
providing a set of regulations;
providing a set of vulnerabilities;
providing a mapping relationship between at least one regulation and at least one vulnerability;
testing a target for a vulnerability in the set of vulnerabilities to determine a vulnerability violation;
associating a regulation in the set of regulations with the vulnerability violation as a function of the mapping to determine a regulation violation.

2. The method of claim 1 wherein the regulations are defined by HIPAA.

3. The method of claim 1 wherein the regulations are defined by GLBA.

4. The method of claim 1 wherein the providing a mapping step further comprises creating a relational database.

5. The method of claim 4 further comprising:
providing a keyword;
scanning the set of regulations by the keyword for a keyed regulation;
scanning the set of vulnerabilities by the keyword for a keyed vulnerability;
grouping the keyed regulation with the keyed vulnerability.

6. The method of claim 1 wherein the testing step further comprises scanning a target to provide a system scan.

7. The method of claim 6 further comprising the step of providing a test set as a function of the system scan.

8. The method of claim 1 further comprising generating a report including an IP address of the target together with the regulation violation.

9. The method of claim 1 further comprising the step of assigning a priority to the regulation violation.

10. The method of claim 1 wherein the set of vulnerabilities are defined by CVE.

11. A security and vulnerability testing system comprising:
a processor;
memory operably connected to the processor;
wherein the memory contains a program executable by the processor to:
search a set of regulations by keyword for a keyed regulation;
search a set of vulnerabilities by the keyword for a keyed vulnerability;
map the keyed regulation to the keyed vulnerability by the keyword to provide a mapping;
test a target for the keyed vulnerability to determine a vulnerability violation;
determine a regulation violation corresponding to the vulnerability violation as a function of the mapping.

12. The system of claim 10 wherein the regulations are defined by HIPAA.

13. The system of claim 10 wherein the regulations are defined by GLBA.

14. The system of claim 10 wherein the set of vulnerabilities are defined by CVE.

15. The system of claim 10 wherein the program is further executable by the processor to scan a target and determine a corresponding test set.

16. The system of claim 10 wherein the program is further executable by the processor to generate a report including an IP address of the target together with the regulation violation.

17. Computer-executable process steps, stored on a computer-readable medium and executable by a processor to perform the steps of:
search a set of regulations by keyword for a keyed regulation;
search a set of vulnerabilities by the keyword for a keyed vulnerability;
map the keyed regulation to the keyed vulnerability to provide a mapping;
test a target for the keyed vulnerability to determine a vulnerability violation;
determine a regulation violation by the keyed vulnerability as a function of the mapping.

18. The steps of claim 17 wherein the regulations are defined by HIPAA.

19. The steps of claim 17 wherein the regulations are defined by GLBA.

20. The steps of claim 17 wherein the set of vulnerabilities are defined by CVE.

21. The steps of claim 17 further executable by the processor to scan a target and determine a corresponding test set.

22. The steps of claim 17 further executable by the processor to generate a report including an IP address of the target together with the regulation violation.

23. The steps of claim 17 further executable by the processor to assign a priority to the regulation violation.
